(19) United States
(12) Patent Application Publication
(10) Pub. No.: US 2025/0384453 A1
(43) Pub. Date: Dec. 18, 2025

(54) INTRINSIC AND EXTRINSIC FACTORS IN DYNAMIC OPTIMIZATION EXPERIMENTS

(71) Applicant: JACQUARD GROUP LIMITED, London (GB)

(72) Inventor: Neil YAGER, North Vancouver (CA)

(73) Assignee: JACQUARD GROUP LIMITED, London (GB)

(21) Appl. No.: 18/740,753

(22) Filed: Jun. 12, 2024

(51) Int. Cl. G06Q 30/0201

(52) U.S. Cl. CPC G06Q 30/0201

(57) ABSTRACT

A method for optimizing the transmission of data transmitted from a system computer via a network to a plurality of user computers where a first batch of data comprising a plurality of content variants is transmitted to a select percentage of the plurality of user computers and performance metrics are gathered for each of the content variants where intrinsic and extrinsic factors are quantified such that proportions of the content variants are adjusted for inclusion in a second batch of data based solely on the intrinsic data.

### BACKGROUND

### 1. Field of the Invention

The present disclosure is related to a method for testing responsiveness to transmitted data. More particularly, the present disclosure is related to a method for optimizing content transmitted to a plurality of user computers to achieve desired performance metrics.

### 2. Description of Related Art

In marketing, there are countless ways to craft the language or imagery used in a campaign. However, while marketers can look to past successes, there is no way to know ahead of time which variations will be most effective for the selected audience. Therefore, they often run experiments to find the best-performing content and maximize the portion of the audience to which the optimized content is sent.

One challenge facing marketers is that the inherent quality of the content tested is only one factor that impacts performance metrics. For example, an audience might be more receptive to promotions and discounts in the weeks leading up to Christmas. This will improve the performance of all marketing content, regardless of quality. Traditional optimization methodologies do not explicitly disentangle intrinsic and extrinsic factors. This in turn, leads to missing context, incorrect conclusions, and suboptimal outcomes.

One known approach for optimizing marketing content is to use a multi-armed bandit (MAB) algorithm. The MAB process can be described as follows:
1) Generate content variants. These could include, as an example, different versions of an email subject line.
2) Decide on a performance metric to be maximized. For email subject lines an “open rate” (e.g., the number of emails opened divided by the number of emails delivered) could be used.
3) Decide on the selection strategy. This is the logic used to determine which variant to deliver when there is a content request. A common strategy (called ε-Greedy) is to select the best-performing variant most of the time and a random variant the rest of the time. This balances exploration (testing) and exploitation (using the current best known performing data).

Run an experiment. Next, an experiment can be run based on the above, which proceeds as follows:
4) When there is a new request for content, use the above selection strategy to pick a variant.
5) Wait some time to measure the outcome. For example, in the case of email subject line optimization, wait hours (or days) to determine if the recipient opens the email.
6) Update the parameters of the MAB model using the latest performance metrics. For example, calculate the total open rate for each content variant. Over time, the MAB algorithm dynamically allocates more email deliveries to the variants with higher open rates.
7) Repeat steps 4-6.
8) Stop the experiment.

This generalized approach is depicted in FIG. 1. However, this approach has a fundamental flaw. There is a hidden and underlying assumption that the observed performance is an inherent property of the content delivered. However, the actual performance may be due to many factors including but not limited to: the demographics of the recipients, the time of day the email was sent, the time of year the email was sent, upcoming holidays relative to when the email was sent, current macroeconomic trends, current world events, network delivery issues impacting the communications, random noise, and so on. This is not an exhaustive list, but these factors are known as “extrinsic” factors because they are not dependent on the variants themselves. The influence of extrinsic factors can also vary over time.

Consider the following example of an experiment lasting two days and testing two content variants:

TABLE 1

| | Day 1 | Day 2 | Total |
|---|---|---|---|
| Variant A | 40% (400/1000) | 11% (209/1900) | 21% (609/2900) |
| Variant B | 38% (380/1000) | 10% (100/1000) | 24% (480/2000) |

As can be seen, Variant A had the highest “open rate” on Day 1. Therefore, it was allocated a greater proportion of sends on Day 2. On Day 2, however, the overall engagement levels of the audience were lower than Day 1. But, once again, Variant A achieved a higher open rate than Variant B. It should be noted that the “Total” open rate for Variant A at 21% is lower than the Total open rate for Variant B at 24% even though Variant A performed better in terms of open rate than Variant B for both days. The high volume of deliveries on the second day accounts for this, which had low overall engagement. This phenomenon is known as “Simpson's paradox.” If one looks only at the Total statistic, this is misleading. Based on this, a standard implementation of a MAB algorithm would then give Variant B a higher proportion of sends on Day 3. However, this decision would not be correct since Variant A consistently had a higher open rate. As such, this would be a failed optimization.

Accordingly, there is a need for an optimization method that overcomes, alleviates, and/or mitigates one or more of the aforementioned and other deleterious effects of prior art optimization methods.

### SUMMARY

Accordingly, what is needed is a system and method for optimizing data transmitted via a network connection to a plurality of target computers that optimizes content variants of the transmitted data to best achieve a performance metric.

It is desired to provide a system and method for optimizing data transmitted via a network to a plurality of target computers that identifies both intrinsic and extrinsic factors and uses only intrinsic factors in updating parameters to determine data transmission strategy.

It is further desired to provide a system and method for optimizing data transmitted via a network to a plurality of target computers that can filter out non-variant quality factors relating to a performance metric that is being measured to ensure the quality of a content variant is being accurately measured.

As such, a dynamic optimization experiment aims to maximize the delivery of high-quality content to as much of an audience as possible according to a configuration of the invention.

In one configuration, a dynamic optimization experiment method includes curating a set of content variants for testing. Of the content variants, one will be designated as a control variant.

The next step in the optimization method is to create a first batch. A batch is a set of user devices that are associated with different users. Batches can be audience-based or time-based. For each batch, the variants have a fixed proportion of deliveries. It is important that the mapping between variants and recipients within a batch is randomized to avoid systematic biases.

The content variants may then be delivered to their intended recipients. The results are then gathered over a time period.

Next, the results are then looked at and an effort is made to remove the impact that extrinsic factors may have on the results. This involves looking at and quantifying both intrinsic factors and extrinsic factors.

An intrinsic factor can be analyzed as the relative performance between a variant and the control variant.

An extrinsic factor can be defined as the performance of the control variant in each batch. Since the control variant is the same from batch to batch, changes in its performance metrics are not due to the content itself but rather external forces impacting all variants.

From this point, values for the intrinsic and extrinsic parameters can be determined. One solution is to determine the optimal values for all parameters simultaneously. This can be accomplished using an optimization algorithm, such as least squares, gradient descent, simplex, evolutionary algorithms, etc. Optimization algorithms require an objection function to minimize (or maximize). The objective function measures the distance between the observed results and those predicted by a set of parameter values. Examples include the sum-of-squared differences or the L1 norm function. The optimization algorithm finds values for the parameters that are the best fit for the observed results.

After parameter estimation, the intrinsic parameters alone determine the variant proportions for the next batch. When the proportions for the next batch have been determined, a new batch is created. This batch has a higher proportion of sends for the variants that are expected to perform well. This process can continue indefinitely, with the proportions of each new batch being based on some (or all) of the results in previous batches

For reporting, intrinsic parameters are used to report on the relative performance of the tested variants. This can be done for a single campaign, where the variants are ranked based on their intrinsic quality. Alternatively, multiple experiments' variants can be examined together to find correlations between content and performance. The extrinsic parameters can be used to help understand when an audience is most receptive to marketing communications.

All the incremental values for each batch can be added to get the overall number of incremental opens for the experiment. The same process can be followed for other performance metrics

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The term “network” as used herein includes both networks and internetworks of all kinds, including the Internet, and is not limited to any particular type of network or inter-network.

The terms “first” and “second” are used to distinguish one element, set, data, object or thing from another, and are not used to designate relative position or arrangement in time.

The terms “coupled”, “coupled to”, “coupled with”, “connected”, “connected to”, and “connected with” as used herein each mean a relationship between or among two or more devices, apparatus, files, programs, applications, media, components, networks, systems, subsystems, and/or means, constituting any one or more of (a) a connection, whether direct or through one or more other devices, apparatus, files, programs, applications, media, components, networks, systems, subsystems, or means, (b) a communications relationship, whether direct or through one or more other devices, apparatus, files, programs, applications, media, components, networks, systems, subsystems, or means, and/or (c) a functional relationship in which the operation of any one or more devices, apparatus, files, programs, applications, media, components, networks, systems, subsystems, or means depends, in whole or in part, on the operation of any one or more others thereof.

The term “content variant” as used herein means email subject lines, calls to action, images, and the like.

The term “performance metric” as used herein means open rate, click rate, shares, and the like.

The term “performance difference” as used herein means the ratio (or “uplift”) between variants, or absolute differences.

The term “parameter” as used herein means a variable that is part of the model where its value is estimated based on the data.

The term “objective function” as used herein means a formula that measures the distance between observed data and the output of the model for given parameters. An objective function can comprise, for example, Sum-of-Squared differences, L1 Norm Function, and the like.

The term “optimization algorithms” as used herein means an algorithm that finds the best-fit parameters for the objective function, such as, for example, a gradient descent, simplex, least squares, evolutionary, Levenberg-Marquardt, and the like.

In one configuration a method for optimizing the transmission of data transmitted from a system computer via a network to a plurality of user computers, the system computer having a storage, the method comprising the steps of: determining a plurality of user computers to receive the data and selecting a plurality of content variants, which are saved on the system computer. The method further comprises the steps of: selecting one of the generated content variants as a control variant and generating a first batch of data with the system computer. The method is provided such that each content variant of the first batch is transmitted to a select percentage of the plurality of user computers. The method still further comprises the steps of: receiving with the system computer performance metrics for each of the content variants in the first batch of data, and the system computer generates an engagement model comprising intrinsic factors and extrinsic factors and saving the engagement model on the storage. The method also comprises the steps of: quantifying the intrinsic factors and extrinsic factors based on the performance metrics for each of the content variants in the first batch of data, and adjusting proportions of the content variants for inclusion in a second batch of data based solely on isolated intrinsic factors. Finally, the method is provided such that each content variant of the second batch is transmitted to a select percentage of target user computers based on the adjusted proportions.

The above-described and other features and advantages of the present disclosure will be appreciated and understood by those skilled in the art from the following detailed description, drawings, and appended claims.

### DESCRIPTION OF THE DRAWINGS

FIG. 1 is a flow diagram of a generalized approach for optimizing marketing content according to the prior art;

FIG. 2 is a flow diagram for optimizing the transmission of data according to one configuration of the present invention;

FIG. 3 is a flow diagram describing the optimization algorithm according to FIG. 2; and

FIG. 4 is a block diagram of a system for optimizing the transmission of data according to FIG. 2.

### DETAILED DESCRIPTION

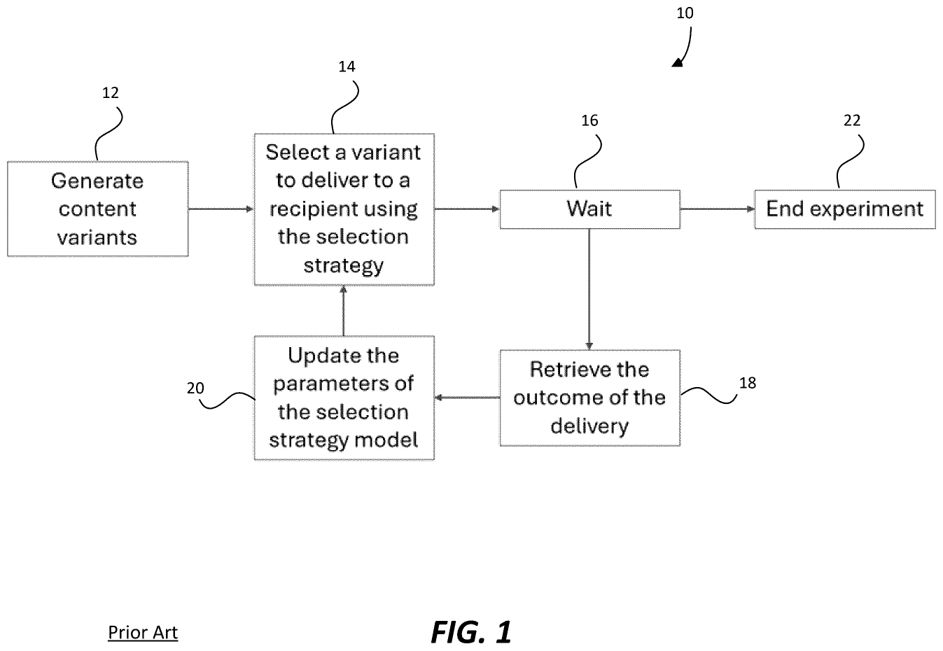

Referring to the drawings, FIG. 1 depicts a method 10 according to the prior art. In this method, content is generated 12, where a variant is selected to be delivered to a recipient via a selection strategy 14. After the variant is sent, the method must wait 16 for results to develop. The results are eventually retrieved 18, which results are then used to update the parameters of the selection strategy 20 as previously discussed. Once enough iterations are performed, the experiment ends 22.

As stated previously, a problem with this type of method is that extrinsic factors can have a large impact on the performance metrics that can function to alter the outcome of the experiment leading to inaccurate results.

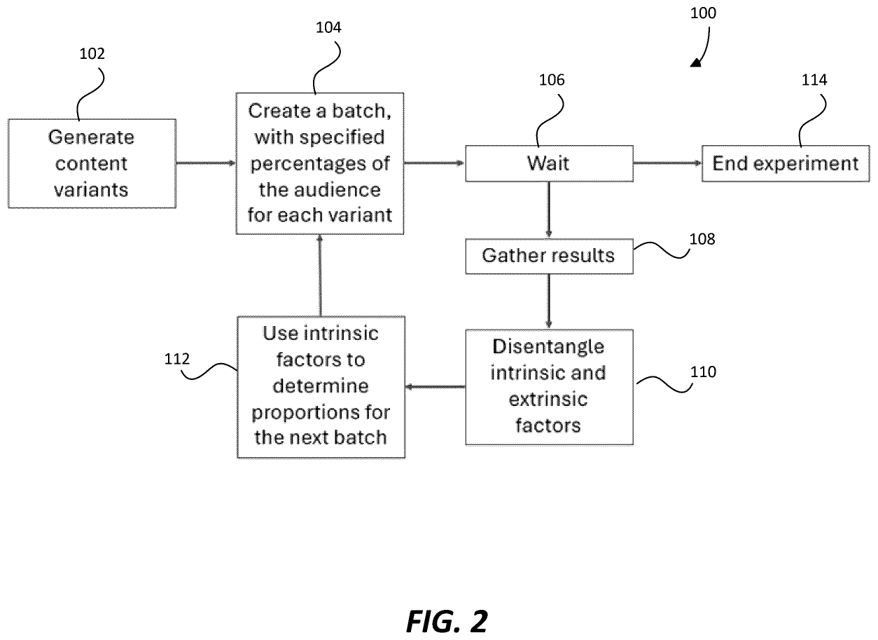

Discussing FIG. 2, a dynamic optimization experiment aims to maximize the delivery of high-quality content to as much of an audience as possible. FIG. 2 contains the proposed updated workflow for running a dynamic optimization experiment. Compared to FIG. 1, the key differences are:
Dividing the audience into batches with fixed percentages for each variant
Using a mathematical model to disentangle the impact of intrinsic and extrinsic factors
Using the intrinsic factors as a basis for updating the variant percentage for the next batch
Using the intrinsic and extrinsic factors separately to provide real-time reporting and analysis of an experiment

FIG. 2 depicts a flow diagram for optimizing the transmission of data 100. A first step is to generate content variants 102, which could comprise any variants as previously discussed. Once the content variants are generated, the method includes the step of creating a batch where specified percentages of the audience (user computers associated with users) being assigned to receive each variant 104.

The batch is sent out to the audience based on the above-assigned percentages 106 where time is then needed to allow for responses to be logged. The results are then gathered 108 over a time period.

Next, the results are then looked at and an effort is made to remove the impact that extrinsic factors may have on the results 110. This involves looking at and quantifying both intrinsic factors and extrinsic factors.

These steps will be discussed in greater detail below. It should be noted that, while various functions and methods will be described and presented in a sequence of steps, the sequence has been provided merely as an illustration of one advantageous configuration, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions described herein.

The first step in running a dynamic optimization experiment is to curate a set of content variants for testing. The content variants can be text, audio, imagery, video, or a combination of these formats. The source of this content can be from generative AI, such as an LLM, or from human copywriters or artists. The number of variants to test depends on several factors, such as the audience size and the desired statistical power. Using ten content variants is typically a good starting point. One of these variants is designated as the control variant. This control variant can be, for example: a variant created by a person, a variant that has historic significance, or a champion of a previous experiment.

The next step is to create the first batch. A batch is a set of people. There are two ways to define batches:
1) Audience-based: The people receiving a marketing communication are known in advance. For example, consider a campaign to inform previous customers about a sale event. In this case, batches can be defined as subsets of previous customers. For example, the total available audience can be divided into 20 batches, each containing a random 5% of the previous customers.
2) Time-based: The audience members are not known in advance. For example, consider a marketing campaign that sends reminders to people who add a product to their online shopping cart but do not complete the purchase. In this case, the message is triggered by a real-world event. A batch can be defined as the people receiving the marketing communication within a specified time window. For example, a batch might be defined as the people who receive a message between 10 a.m. and 11 a.m. on the 3rd day of an experiment.

For each batch, the variants have a fixed proportion of deliveries. For example, for Batch 4, Variant A might get 14% of deliveries, Variant B might get 4% of deliveries, and so on. It is important that the mapping between variants and recipients within a batch is randomized to avoid systematic biases.

Interacting with an external system through a network API is often necessary to deliver the content variants to their intended recipient. For example, in the case of email, an Email Service Provider (ESP) or Customer Engagement Platform (CEP) can be used to handle the delivery of the emails and tracking results.

Batch Results. Companies can use multiple channels to communicate with their customer base. These include email, SMS, in-app push messaging, website body copy, social media, etc. The only requirement for optimization is that there is a way to quantify the success of the individual variants.

Assume we are experimenting to find the best email subject line for a marketing campaign. For each email sent, the recipient will either open the email or delete/ignore it. Assume that the performance metric we wish to optimize is the open rate (the number of emails opened divided by the number of sent). Other possible metrics are click rates (the percentage of people who follow a link in the email) or conversion rates (the percentage of people who buy a product after reading an email).

People do not continuously monitor their email inboxes 24 hours a day. When a new batch is first sent, the open rates are, by definition, 0% because people have not yet had an opportunity to see the email in their inbox and decide whether to open it. The email open rates grow over time and typically converge near their final value after 2-3 days. It is advisable to monitor and update the results of a batch throughout this period. For example, the latest open rates can be polled every 15 minutes until the results converge.

Within each batch, the open rate is calculated for each variant. Table 2 contains sample performance data for an experiment with three content variants. The table shows the number of opens, the number of sends, and the open rate:

TABLE 2

| | Batch 1 |
|---|---|
| Variant A | 12/100 = 12% |
| (control) | |
| Variant B | 14/100 = 14% |
| Variant C | 10/100 = 10% |

Disentangle intrinsic and extrinsic factors. A dynamic optimization experiment is an ordered sequence of batches sent over time. Table 3 contains sample data for an experiment with three variants and four batches:

TABLE 3

| | Batch 1 | Batch 2 | Batch 3 | Batch 4 |
|---|---|---|---|---|
| Variant A | 12/100 = 12% | 18/100 = 18% | N/A | 5/50 = 10% |
| (control) | | | | |
| Variant B | 14/100 = 14% | 43/200 = 22% | 48/500 = 10% | 35/300 = 12% |
| Variant C | 10/100 = 10% | 7/50 = 14% | 2/33 = 6% | 1/10 = 10% |

As seen in Table 3, there is a performance metric for each batch/variant combination. Three main factors are driving the observed open rates:

Intrinsic quality of the content variants. This explains some of the observed variance of the open rates within the batches. For example, consider Variant A and Variant B in Batch 1.These had open rates of 12% and 14% respectively. The hypothesis is that Variant B achieved a higher open rate because the audience prefers this content over Variant A.

Extrinsic factors. The overall level of audience engagement varies from batch to batch. This can be seen by looking at the performance of a single variant over time. For example, Variant B had open rates of 14%, 22%, 10% and 12%, even though the variant content is constant. The extrinsic factors driving these changes vary from experiment to experiment. For example, in this case, it is possible that Batch 2 was sent on a weekend, and the other batches were sent on weekdays.

Statistical noise. Sampling error is inevitable when performance metrics are estimated based on a subset of a population. The amount of noise is inversely proportional to the sample size. Some noise will be present in all observed open rates, so quantifying statistical uncertainty is important.

Defining how to calculate the intrinsic and extrinsic factors will now be discussed.

Intrinsic: One way to measure the intrinsic factor is the relative performance between a variant and the control variant. The ratio:

$$\frac{variant performance}{control performance} - 1$$

is relatively stable over time. It is often referred to as a variant's “uplift” and is positive when a variant performs better than the control or negative when a variant performs worse than the control.

Extrinsic: The extrinsic factor can be defined as the performance of the control variant in each batch. Since the control variant is the same from batch to batch, changes in its performance metrics are not due to the content itself but rather external forces impacting all variants.

The next step is to find values for the intrinsic and extrinsic parameters. In some cases, it may be possible to calculate these values directly and independently. However, this is not a robust solution. When calculated this way, the parameters are sensitive to noise or may be missing entirely.

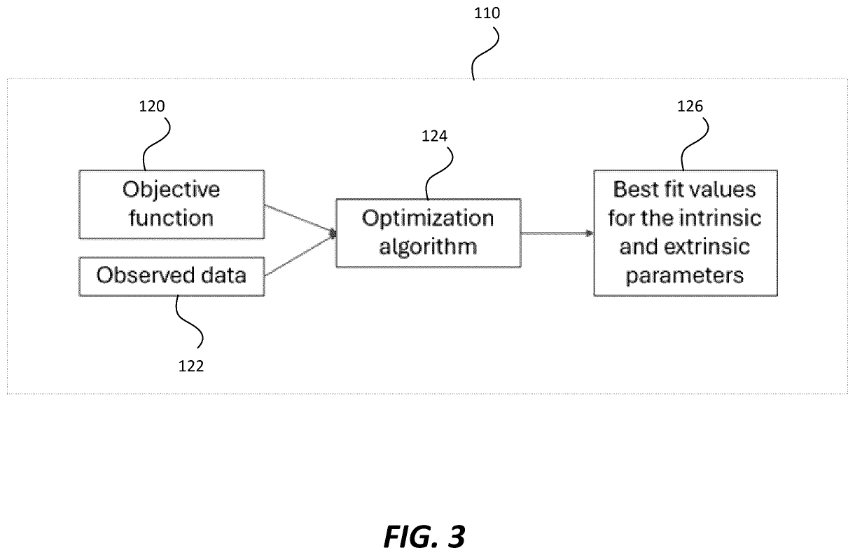

A better solution is to determine the optimal values for all parameters simultaneously as depicted in FIG. 3. This can be accomplished using an optimization algorithm 124, such as least squares, gradient descent, simplex, evolutionary algorithms, etc. Optimization algorithms require an objection function to minimize (or maximize). The objective function 120 measures the distance between the observed results 122 and those predicted by a set of parameter values. Examples include the sum-of-squared differences or the L1 norm function. The optimization algorithm finds values for the parameters that are the best fit for the observed results 126 as illustrated in FIG. 3.

There are two main benefits to framing this as a global optimization problem:
This approach uses all data available for every parameter, increasing robustness against statistical noise.
This approach supports missing values. e.g. variants can be missing from some batches. Excluding some variants (such as the control) reduces the opportunity cost of testing.

Consider the data presented in Table 3. Here is an example of the output of the optimization algorithm for that data:

TABLE 4
Intrinsic parameters

| | Variant B | Variant C |
|---|---|---|
| Uplift relative | +20% | −20% |
| to the control | | |

TABLE 5
Extrinsic parameters

| | Batch 1 | Batch 2 | Batch 3 | Batch 4 |
|---|---|---|---|---|
| Baseline | 12% | 18% | 8% | 10% |
| open rate | | | | |

Note in Table 3 that the control was not included in Batch 3. However, by framing this as a global optimization problem, the proposed method still estimates the control's open rate for this batch.

There is an unexpected benefit to disentangling intrinsic and extrinsic data. As mentioned above, open rates start at 0%, grow over time, and converge on their final values after days or weeks. This is because only a portion of the audience has seen the email in their inbox. The “percentage of an audience that has seen an email in the inbox” is a well-defined extrinsic factor. It is modelled by the proposed approach and isolated from the intrinsic factors. Therefore, the intrinsic factors of a batch's variants can be used almost immediately (e.g. 15 minutes after a batch has been sent) without waiting for convergence (which can take days). Including this immature data in the engagement model accelerates the optimization and adds to the robustness of the approach.

Use intrinsic factors to determine proportions for the next batch. After parameter estimation, the intrinsic parameters determine the variant proportions for the next batch. This has the advantage that the proportions are based on the inherent quality of content variants rather than external factors impacting results. Furthermore, it avoids the problem of Simpson's Paradox, where poor-quality content appears to have high performance. Simpson's Paradox can occur when extrinsic factors (such as the day of the week or the length of time since a batch was sent) are not accounted for when calculating the performance of individual variants.

There are several ways to use the intrinsic factors. Assume that Batches 1 to X have been sent, and the intrinsic and extrinsic parameters have been calculated. The next step is to calculate the proportions for Batch X+1. A simple MAB approach would be to use the ε-Greedy strategy. In this case, the variant with the highest uplift gets the most sends in Batch X+1, and the other variants get a smaller proportion. For example, using the results from Table 4, Variant B might get 90% of the deliveries in Batch X+1, while Variants A and C each get 5%. This balances exploitation (sending the best variant to the most people) and continued exploration (gaining statistical confidence in the results).

One limitation of the ε-Greedy approach is that it does not consider statistical uncertainty. Early in an experiment, a more balanced distribution can help find the best content more quickly. Other MAB strategies can address this shortcoming.

In the preferred embodiment, a Monte Carlo simulation is used to determine the impact of statistical noise on the experiment's outcome. The data is sub-sampled for the purpose of bootstrapping. For example, assume that a variant had 14/20 opens in a batch. This is an open rate of 70%. Simulating an alternative number of opens is possible by drawing 20 random samples from a binomial distribution with a probability of success of 70% and counting the number of successes. For large samples, the resulting open rate will be close to the observed open rate. However, more variation will occur when the outcome is based on fewer samples.

This can be done for every variant and batch combination many times. For example, 200 times. The parameters of the engagement model can be recomputed for each bootstrap. This gives a range of intrinsic and extrinsic parameter values (instead of point estimates). This allows us to create non-parametric confidence intervals by finding percentiles of the bootstrapped values. For example, using the 2.5% and 97.5% percentiles, we can say that a variant has a 20% uplift against the control with a 95% confidence interval of [17% to 23%]. The width of the interval reflects how much confidence we have in the calculated parameters.

Another advantage of the Monte Carlo simulation is that it can be used to determine the probability of a variant having the highest performance in the next batch. Due to the nature of the simulation, this automatically takes statistical uncertainty into account. Early in an experiment, the chance of any individual variant winning will be relatively uniform (due to the limited data available and the impact of random noise). However, as more data is gathered, better-performing variants will win the simulation more often. The estimated probability of winning has several uses, including:
It can be used to determine batch proportions. For example, this can be as simple as a mapping between the chance of a variant winning and its batch proportion. e.g. If a variant has an 87% chance of winning the next batch, it can be sent to 87% of the recipients.
It can be used to drop poor-quality variants from the experiment. For example, if a variant has a 1% or less chance of being the champion in the next batch, it can be dropped from the experiment. New variants can optionally be introduced in its place.
   Note that the Monte Carlo simulation can be computationally expensive when there are many batches and variants. Since each bootstrap is independent, this computation can be parallelized and offloaded to an external and high-performance networked computer to reduce the runtime.

Create a new batch. When the proportions for the next batch have been determined, a new batch is created. This batch has a higher proportion of sends for the variants that are expected to perform well. This process can continue indefinitely, with the proportions of each new batch being based on some (or all) of the results in previous batches.

For long-running experiments, it may be advisable to let batches expire. For example, one might wish to ignore batches sent more than three months ago. This allows the experiment to adapt to changing preferences in an audience.

Ending the experiment. There are multiple possible reasons for ending an experiment. This decision is usually based on the nature of the experiment:
Audience-based:
   A variant has been delivered to every audience member
Time-based:
   The marketing event being promoted has ended
   The best-performing content has been identified with a desired degree of statistical certainty.

Experiment analysis and reporting. Having reports analyzing an experiment and its outcome is helpful. The reporting can be done in real-time while the experiment is running or after its completion. The reports provide useful insights for the company running the marketing campaign. Both intrinsic parameters and extrinsic parameters are useful for this purpose.

Intrinsic parameters. The main use of intrinsic parameters is to report on the relative performance of the tested variants. This can be done for a single campaign, where the variants are ranked based on their intrinsic quality. Alternatively, multiple experiments' variants can be examined together to find correlations between content and performance. For example, it is possible to check for a relationship between the properties of the variants, such as length and sentiment, and their intrinsic parameters. This allows for insights like “this audience tends to respond favorably to short messages with a strong sense of urgency.”

The intrinsic parameters can also be used as training data for machine learning models. For example, these models can be trained to predict the performance of new variants in future batches or experiments.

Extrinsic parameters. The extrinsic parameters can help us understand when an audience is most receptive to marketing communications. For example, they allow for insights like “this audience is 14% more likely to open emails in the 2 weeks before Christmas”.

Extrinsic parameters can also be used to quantify the success of an experiment. One way to do this is to analyze each batch independently. Consider the final batch (Batch 4) of the experiment data presented in Table 2. There are three steps:
1. Calculate the total number of opens and sends across all variants. For Batch 4, that is 41 opens out of 360 emails sent.
2. Calculate the hypothetical number of opens that would have been achieved if no experiment had been run. In other words, if the control had been sent to everyone in the batch. The extrinsic parameter for Batch 4 is 10% (Table 4). Therefore, we predict that approximately 36 emails (10%×360) would have been opened if the control had been sent to everyone.
3. Calculate the difference between the actual number of opens and the predicted number of control variant opens. For Batch 4 the experiment resulted in 41−36=5 incremental opens. In other words, 5 emails were opened that would not have been opened if the control had been sent to everyone.

The final step is to add all the incremental values for each batch to get the overall number of incremental opens for the experiment. The same process can be followed for other performance metrics.

Incremental opens can be converted into monetary values when supporting data is available. For example, if it is known that every opened email, on average, results in $2 dollars of sales, we can estimate that Batch 4 resulted in 5×$2=$10 of incremental revenue. Note that these numbers are for illustrative purposes only. It is not unusual for marketing campaigns to reach millions of people.

Mathematical details of the optimization. Assume there are M variants. The vector for the intrinsic parameters is:

$$Δ = ( \begin{matrix}{Δ}_{1} \\ {Δ}_{2} \\ ⋮ \\ {Δ}_{M}\end{matrix} )$$

where Δi is the relative performance of the ith variant (e.g. compared to the control variant).

The extrinsic factor can be defined as the performance of the control variant in each batch. Assume there are N batches. The vector for the extrinsic parameters is:

$$θ = ( \begin{matrix}{θ}_{1} \\ {θ}_{2} \\ ⋮ \\ {θ}_{N}\end{matrix} )$$

where θj is the performance of the control variant for batch j.

The next step is to find values for the parameters that best match the observed results. This can be accomplished using an optimization algorithm. Optimization algorithms require an objection function that measures the distance between the observed results and those predicted by a set of parameter values.

Let S be an M×N matrix, where sij is the number of sends for variant i and batch j. Let O be an M×N matrix, where oij is the number of opens for variant i and batch j. Here is an example objective function based on the sum of squared differences between the observed results and the predicted results for parameters Δ and θ:

$$Objective Function = {\sum }_{i = 1}^{M} {\sum }_{j = 1}^{N} {( ( {Δ}_{i} {θ}_{j} ) \cdot {s}_{ij} - {o}_{ij} )}^{2}$$

The global minima of this function can be found using optimization algorithms such as gradient descent or least squares. This will provide “best fit” estimates for intrinsic and extrinsic parameters.

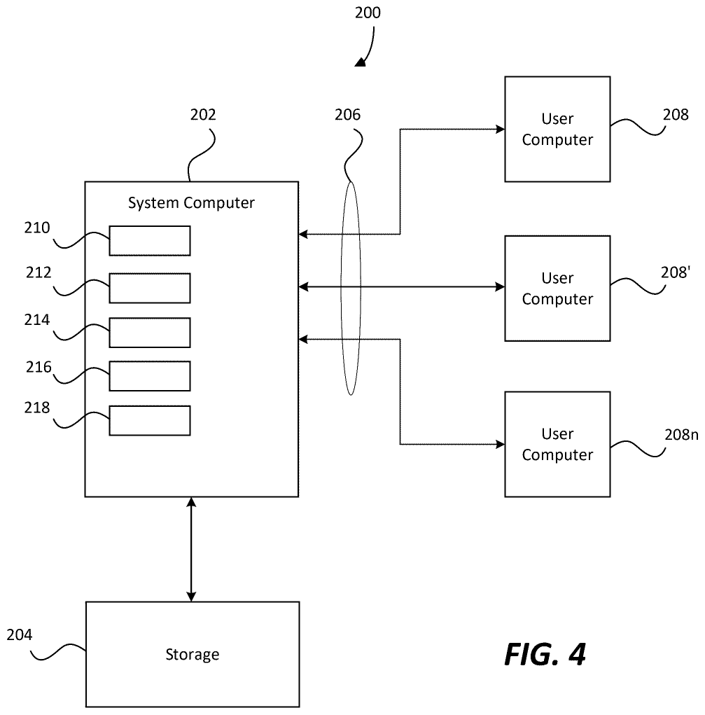

Turning now to FIG. 4, a block diagram of a system for optimizing the transmission of data 200 is illustrated.

System 200 comprises a system computer coupled to a storage 202. The system computer is connected to a plurality of user computers 208, 208′, 208″ via a network connection 206 as shown.

The system computer 202 includes a number of software modules, including content variant module 210, batch module 212, performance metrics module 214, engagement model module 216, and optimization module 218. The function of each of these modules has been discussed in connection with the method of FIG. 2 and will not be redescribed here.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A method for optimizing the transmission of data transmitted from a system computer via a network to a plurality of user computers, the system computer coupled to a storage, the method comprising the steps of:
determining a plurality of user computers to receive the data;
selecting a plurality of content variants, which are saved on the system computer;
selecting one of the generated content variants as a control variant;
generating a first batch of data with the system computer;
wherein each content variant of the first batch is transmitted to a select percentage of the plurality of user computers;
receiving with the system computer performance metrics for each of the content variants in the first batch of data;
the system computer generating an engagement model comprising intrinsic factors and extrinsic factors and saving the engagement model on the storage;
quantifying the intrinsic factors and extrinsic factors based on the performance metrics for each of the content variants in the first batch of data;
adjusting proportions of the content variants for inclusion in a second batch of data based solely on isolated intrinsic factors;
wherein each content variant of the second batch is transmitted to a select percentage of target user computers based on the adjusted proportions.

2. The method of claim 1, wherein the step of quantifying the intrinsic factors and extrinsic factors includes defining an objective function with the system computer and the parameter values are determined by minimizing the objective function using an optimization algorithm.

3. The method of claim 1, wherein content variants are excluded from the second batch based solely on isolated intrinsic factors.

4. The method of claim 1, wherein the intrinsic parameters comprise a performance ratio between a content variant and the control for each variant.

5. The method of claim 4, wherein machine learning utilizes the intrinsic parameters as machine learning training data.

6. The method of claim 1, wherein the extrinsic parameters comprise a performance of the control variant for each batch of the first ordered sequence of distribution batches.

7. The method of claim 6, wherein the extrinsic parameters are used for reporting calculations and analysis including Return On Investment (ROI) and incrementals.

8. The method of claim 6, wherein the extrinsic parameters comprise an open rate for the digital data transmitted to the plurality of user computers.

9. The method of claim 1, wherein the intrinsic and extrinsic parameters are determined by an optimization algorithm selected from the group consisting of: least squares, gradient descent, and combinations thereof.

10. The method of claim 9, wherein the step of determining parameters with the system computer that minimizes the objective function is performed by the optimization algorithm.

11. The method of claim 1, wherein the step of generating an engagement model further comprises the step of:
performing repeated random sampling to obtain a likelihood of occurrence of a range of results.

12. The method of claim 11, wherein the repeated random sampling is used to bootstrap confidence intervals, quantify uncertainty and calculate champion probabilities.

13. The method of claim 1, wherein the content variants are selected from the group consisting of: text, audio, imagery, video, and combinations thereof.

14. The method of claim 1, wherein a number of content variants is correlated to an audience size of the plurality of user computers.

15. The method of claim 1, wherein each batch comprises a percentage of the total number of the plurality of user computers or is based on time windows of when content requests are received on a given day.

16. The method of claim 1, wherein for each batch, the content variants in each of the first and second ordered sequences of distribution batches have a fixed proportion of deliveries.

17. The method of claim 16, wherein mapping between content variants and user computers within a batch is randomized to avoid systematic biases.

18. The method of claim 1, wherein the plurality of content variants comprises an email subject line, and the performance metric is selected from the group consisting of: an open rate for the email, where the open rate is determined by the number of emails opened divided by the number of emails sent, a click rate for the email, and combinations thereof.

19. The method of claim 18, wherein within each batch, the open rate or the click rate is calculated for each email subject line variant.
